(19) United States
(12) Patent Application Publication
(10) Pub. No.: US 2011/0217566 A1
(43) Pub. Date: Sep. 8, 2011

(54) CORROSION-RESISTANT STEEL FOR CHIMNEY/FLUE USE IN NATURAL GAS-FIRED OR LIQUEFIED PETROLEUM GAS-FIRED PLANTS

(76) Inventors: Matoko Nagasawa, Tokyo (JP); Kenji Katoh, Tokyo (JP); Naoki Saitoh, Tokyo (JP); Masayuki Kodama, Tokyo (JP); Mutsuto Tanaka, Tokyo (JP); Fumiaki Nakamura, Tokyo (JP)

(21) Appl. No.: 12/998,559

(22) PCT Filed: Mar. 19, 2010
(86) PCT No.: PCT/JP2010/055482

§ 371 Date: May 2, 2011

(30) Foreign Application Priority Data
Mar. 30, 2009 (JP) 2009082278

(51) Int. Cl. B32B 15/08; B32B 15/01; C22C 38/18; C22C 38/20; C22C 38/22

(52) U.S. Cl. 428/626; 420/60; 420/83; 420/91; 420/103; 420/104; 420/105; 428/684

(57) ABSTRACT

Corrosion-resistant steel for chimney/flue use in natural gas-fired or liquefied petroleum gas-fired plants, containing C: 0.005% to 0.030%, Si: 0.18% to 0.50%, Mn: 1.50% to less than 3.00, P: 0.030% or less, S: 0.0050% or less, Cr: 4.0% to 9.0%, Al: 0.20% to 1.50%, and N: 0.020% or less and able to prevent advanced pitting or other localized corrosion and the resultant hole formation and rust aerial dispersal is provided.

### TECHNICAL FIELD

The present invention relates to corrosion-resistant steel for chimney/flue use, in a natural gas-fired or liquefied petroleum gas-fired plant, from which corrosion resistance, in particular, rust resistance, rust adhesion, and localized corrosion resistance, are demanded.

### BACKGROUND ART

In general, in a chimney or flue of a thermal power plant, cleaning plant, building, station, etc., combustion exhaust gas produced in a boiler is run through a desulfurization apparatus, denitridation apparatus, electrical dust collector, air preheater, flue, or other facility before reaching the chimney and being discharged into the atmosphere.

In recent years, natural gas-fired or liquefied petroleum gas-fired plants have become the mainstream. The structural materials for chimney/flue use are generally carbon steel with a heat resistant coating, concrete, etc. However, with concrete, the site work period at the time of installation or the time of repair becomes longer and the problem of air pollution in the surrounding environment arises.

Under these circumstances, conversion to steel chimneys enabling site installation and repair time to be shortened has been considered. On the other hand, with carbon steel with a heat resistant coating, deterioration of the coating inside the chimney or rusting of the carbon steel causes the problem of aerial dispersal of the peeled off coating or peeled off rust into the surrounding environment.

Solving this problem of aerial dispersal has been a long felt need in the industry in the past, but no cost-economic means for solution satisfying industry has yet been found.

Note that, in structural materials for chimney/flue use, excellent cold workability having, as one indicator, resistance to cold working cracks even if conducting a 180° bending test for a plate thickness of 6 mm when working the materials into a chimney etc. is simultaneously demanded.

Under these circumstances; attempts at improvement of the corrosion resistance from the standpoint of the materials have been proposed as shown below.

In PLT 1, stainless steel for a cleaning structure use including, as the compositions of the steel material, C: 0.045% or less, Si: 0.01 to 0.5%, Mn: 0.5 to 2.0%, P: 0.03% or less, S: 0.003% or less, N: 0.020% or less, Cr: 11 to 12.5%, Ni: 0.01 to 2.0%, and Cu: 0.05 to 2.0% and exhibiting excellent corrosion resistance in an SOx, NOx, or other corrosive environment occurring in a chimney is disclosed.

In PLT 2, austenite stainless steel having a corrosion resistance 10 times or more of that of SS400 steel, almost completely free of rust formation, and excellent in weldability is disclosed.

In PLT 3, steel for chimney/flue use including, as the compositions of the steel material, C: 0.04 to 0.15%, Si: 0.05 to 1.0%, Mn: 0.2 to 1.7%, Cr: over 6% to less than 11%, and Al: 0.07% or less is disclosed.

In PLT 4, steel for chimney/flue use based on 5% Cr steel, reduced in the impurity S to 0.010% or less, furthermore having Ti added in a range of 0.005 to 0.05%, furthermore having Ni added alone in a range of 1.0 to 2.5%, or having a fine amount of Cu or Mo added in combination in a range of 0.10 to 1.0% so as to strikingly improve the pitting resistance/localized corrosion resistance and rust adhesion is disclosed.

In PLT 5, a steel material controlled in chemical compositions to Cr: 0.4 to 6%, Cu: 0.1 to 1%, and Al: 0.005 to 0.1% and excellent in corrosion resistance in a carbon dioxide gas-containing condensation water environment is disclosed. In a flue or chimney of a power generation facility fueled by LNG, the atmosphere is repeatedly moistened and dried and the environment is one in which exhaust gas flows at a large rate, so the rust layer formed on the steel material easily peels off. For this reason, in this literature, the rust prevention effect is low of course. Also, the peeled off powder-like or flake-like iron hydroxides etc. disperse aerially from the chimney to the outside and harm the environment. The invention was reached with the objective of solving this problem.

In PLT 6, corrosion-resistant steel for the exhaust system of an automobile, ship, etc. having a compositions of a steel material containing Si: 0.01% to less than 1.2%, Mn: 0.02 to 2.0%, Cr: 5.5 to 9.9%, and Al: 0.3 to 3.0%, further containing C: 0.02 or less, P: 0.03% or less, S: 0.01% or less, and N: 0.02% on one surface of which a metal with less noble potential to the base material is coated to a thickness of 0.5 to 50 μm is disclosed.

Furthermore, PLT's 7 to 9 disclose, as steel having excellent weld zone toughness and simultaneously excellent corrosion resistance in a condensation corrosive environment, atmospheric corrosive environment, tap water corrosive environment, concrete corrosive environment, seawater corrosive environment, and other corrosive environments, the inventions of steel containing Cr in respectively 4 to 9%, 2 to 7%, and 3 to 11% amounts to which Al is added in respectively 0.1 to 5%, 0.1 to 2%, and 0.1 to 2% amounts. Further, as shown in PLT 10, as sulfuric acid dew point corrosion resistant steel, attempts using low alloy steel have been proposed.

### CITATION LIST

### Patent Literature

PLT 1 Japanese Patent Publication (A) No. 2002-285296
PLT 2 Japanese Patent Publication (A) No. 8-311621
PLT 3 Japanese Patent Publication (A) No. 10-60600
PLT 4 Japanese Patent Publication (A) No. 9-59749
PLT 5 Japanese Patent Publication (A) No. 8-291365
PLT 6 Japanese Patent Publication (A) No. 6-280048
PLT 7 Japanese Patent Publication (A) No. 2004-162119
PLT 8 Japanese Patent Publication (A) No. 2004-162121
PLT 9 International Publication WO2005/087964A1
PLT 10 Japanese Patent Publication (A) No. 2001-164335

### SUMMARY OF INVENTION

### Technical Problem

However, the stainless steel of PLT 1 or PLT 2 was excellent in corrosion resistance and rust resistance, but the selective localized corrosion of the weld heat affected zones became a problem. Further, this was not economical. Reduction of the cost has therefore been demanded.

Further, in the steel material of PLT 3, while low in cost and excellent in corrosion resistance, there were the problem of environmental pollution due to the on-site coating and the problem that once the coating deteriorated or the thickness was reduced due to corrosion, it was impossible to keep rust from aerially dispersing to the ambient environment. Further improvement has therefore been demanded.

Further, in the steel material of PLT 4, while excellent in resistance to peeling of rust and exhibiting excellent results against aerial dispersal of rust and corrosion loss due to the effects of condensation etc. accompanying chimney operation, at the time of long term use, along with the advance of rusting, the rust adhesion falls making periodic work for peeling off the rust formed at the inside surfaces of the chimney/flue necessary. Further improvement was sought. Furthermore, when not operated, rainwater would enter inside the chimney and aggravate the formation of rust in the chimney/flue. This became a problem. Further improvement has therefore been sought.

Furthermore, in the steel material of PLT 5, it was possible to keep, to some extent, the rust layer formed on the steel material from peeling off and powder-like or flake-like iron hydroxides from aerially dispersing from the chimney to the outside and harming the environment, but the effect was not sufficient. Further improvement has been sought from industry.

In the corrosive environment of the exhaust system of an automobile, ship, etc. disclosed in PLT 6, pitting is not allowed, but rusting is permitted. On the other hand, in corrosion-resistant steel for chimney/flue use in natural gas-fired or liquefied petroleum gas-fired plants, prevention of both the advance of pitting and other localized corrosion and the resultant hole formation and aerial dispersal of rust is an important issue.

Furthermore, even with steel materials like those of PLT's 7 to 9 which exhibit excellent corrosion resistance in a condensation corrosive environment or atmospheric corrosive environment, when used for a chimney/flue in a natural gas-fired or liquefied petroleum gas-fired plant, the high level of rust resistance and localized corrosion resistance sought under those environments will not necessarily be sufficiently achieved or even if the rust resistance and localized corrosion resistance are sufficient, the cold bendability will be insufficient. It was learned that these become obstacles at the time of use for a chimney/flue in a natural gas-fired or liquefied petroleum gas-fired plant.

In this way, in a chimney/flue in a natural gas-fired or liquefied petroleum gas-fired plant, the corrosive environment is a corrosive environment completely different from that of an exhaust system of an automobile, ship, etc. Even if using a low alloy steel resistant to sulfuric acid dew point corrosion such as in PLT 10, in a natural gas-fired plant exhaust gas environment, the corrosion mechanism differs from that of sulfuric acid dew point corrosion, so the corrosion resistance of the sulfuric acid dew point corrosion resistant low alloy steel becomes just about two times that of carbon steel and a large amount of peelable rust is produced.

In a chimney/flue in a natural gas-fired or liquefied petroleum gas-fired plant, the chimney/flue is exposed to a special corrosive gas environment with a high concentration of carbon dioxide in the exhaust gas and is often repeatedly started and stopped in each day of operation. The inside of the chimney/flue is repeatedly moistened and dried. Furthermore, it is an environment in which exhaust gas of a large pressure flows, so rust is peeled off, detaches, and is discharged from the chimney along with the combustion exhaust gas. Therefore, it has been necessary to provide the chimney with a filter or dust collector or take other measures for preventing environmental pollution. This has resulted in extra costs.

Therefore, in the chimney/flue of such a plant, measures for the prevention of localized corrosion and aerial dispersal of rust in the material under this specific corrosive usage environment have been sought.

Further, as corrosion-resistant steel for chimney/flue use, the securing of the cold workability required for working the steel into a chimney/flue has been sought.

In the above way, in conventional corrosion-resistant steel, a steel material which can be applied to the chimney/flue in a natural gas-fired or liquefied petroleum gas-fired plant and which is satisfactory cost-wise as well has not existed. For a long time, a steel material which satisfies the above demands has been sought from industry.

Therefore, the present invention has as its object the provision of economical corrosion-resistant steel for chimney/flue use in natural gas-fired and liquefied petroleum gas-fired plants which, in the corrosive environment of a chimney/flue in a natural gas-fired or liquefied petroleum gas-fired plant, can prevent the advance of pitting or other localized corrosion and resultant hole formation and prevent the formation of rust or, even if rust is formed, keeps it to a small amount and maintains the adhesion of the rust to the base iron and therefore reliably prevents aerial dispersal of rust, that is, is excellent in rust resistance, rust adhesion, and localized corrosion resistance (pitting resistance), and which is provided with the cold workability required at the time of use for the gas-fired plant chimney/flue.

### Solution to Problem

The gist of the present invention aimed at solution of the above problem is as follows:

(1) Corrosion-resistant steel for chimney/flue use in natural gas-fired or liquefied petroleum gas-fired plants, excellent in rust resistance, rust adhesion, and localized corrosion resistance, characterized by containing, by mass %,

### C: 0.005% to 0.030%,

### Si: 0.18% to 0.50%,

Mn: 1.50% to less than 3.00,
P: 0.030% or less,
S: 0.0050% or less,

### Cr: 4.0% to 9.0%,

### Al: 0.20% to 1.50%,

N: 0.020% or less, and
having a balance of Fe and unavoidable impurities.
(2) Corrosion-resistant steel for chimney/flue use in natural gas-fired or liquefied petroleum gas-fired plants as set forth in (1), characterized by further containing, by mass %,

### Cu: 0.05% to 0.50% and

### Ni: 0.05% to 0.50%.

(3) Corrosion-resistant steel for chimney/flue use in natural gas-fired or liquefied petroleum gas-fired plants as set forth in (1) or (2), characterized by further containing, by mass %, one or more of

### Mo: 0.01% to 0.20%,

### V: 0.005% to 0.050%,

### Nb: 0.005% to 0.050%, and

Ti: 0.005% to less than 0.030%.
(4) Corrosion-resistant steel for chimney/flue use in natural gas-fired or liquefied petroleum gas-fired plants as set forth in (1) or (2), characterized by further containing, by mass %, one or more of

### Ca: 0.0005% to 0.010%,

### Mg: 0.0005% to 0.010%, and

### REM: 0.001% to 0.010%.

(5) Corrosion-resistant steel for chimney/flue use in natural gas-fired or liquefied petroleum gas-fired plants as set forth in (1) or (2), characterized in that it has on its surface a 5 to 100 μm thick inorganic zinc-rich primer layer containing metal zinc in an amount of 30 mass % or more.
(6) Corrosion-resistant steel for chimney/flue use in natural gas-fired or liquefied petroleum gas-fired plants as set forth in (5), characterized in that it has, on an outer surface side of the inorganic zinc-rich primer layer, a 20 to 400 μm thick silicone-based resin layer.

### ADVANTAGEOUS EFFECTS OF INVENTION

In the above way, according to the present invention, it is possible to provide economical corrosion-resistant steel for chimney/flue use, in a natural gas-fired and liquefied petroleum gas-fired plant, which can prevent the advance of pitting or other localized corrosion and the resultant hole formation and can reliably prevent aerial dispersal of rust in the corrosive environment of a chimney/flue in a natural gas-fired or liquefied petroleum gas-fired plant, that is, is excellent in rust resistance, rust adhesion, and localized corrosion resistance (pitting resistance).

### DESCRIPTION OF EMBODIMENTS

Below, embodiments of the present invention will be explained in detail.

The present invention is corrosion-resistant steel for chimney/flue use which achieves both economy and rust resistance/rust adhesion/localized corrosion resistance in the chimney/flue environment of the gas-fired plant by being coated with an inorganic zinc-rich paint while having a composition of less alloy elements compared with the general stainless steel.

Specifically, the steel for a chimney/flue in a natural gas-fired or liquefied petroleum gas-fired plant of the present invention is based on a composition containing, by mass %, C: 0.005 to 0.030%, Si: 0.18 to 0.50%, Mn: 1.50 to less than 3.00, P: 0.030% or less, S: 0.0050% or less, Cr: 4.0 to 9.0%, Al: 0.20 to 1.50%, and N: 0.020% or less and having a balance of Fe and unavoidable impurities and, furthermore, selectively containing elements for improving its properties.

Below, the reasons for limiting the compositions of the steel material of the present invention will be explained. Note that, the unit “%”, unless otherwise indicated, means “mass %”.

[C: 0.005% to 0.030%]

C is an element which improves the strength. 0.005% or more is necessary, but if over 0.030% is added, Cr-based carbides are formed and thereby the corrosion resistance deteriorates, so the upper limit of the addition was made 0.030%. Note that, if considering the balance of the strength and ductility, toughness, and weldability, 0.005% to 0.020% is preferable. Furthermore, if considering the stability in manufacture for achieving this balance, 0.010% to 0.020% is preferable.

[Si: 0.18% to 0.50%]

Si is effective if added as a deoxidizing agent and strengthening element to steel containing Cr in an amount of 2% or more, but if the content is less than 0.18%, the deoxidizing effect is not sufficient, as a result, the solute oxygen and Al easily form oxides, and, as explained later, it no longer becomes possible to sufficiently secure an amount of dissolved Al effective for improving the stability of the passivation layer. On the other hand, if including over 0.50%, the effect becomes saturated and the toughness can fall, so the range of content is limited to 0.18% to 0.50%. Furthermore, if considering the manufacturability and weldability of the steel material, 0.20% to 0.30% is preferable.

[Cr: 4.0% to 9.0%]

Cr, together with the later explained Al, improves the stability of the passivation layer and thereby secures corrosion resistance, so has to be included in an amount of 4.0% or more, but even if over 9.0% is included, not only is the cost increased, but also the toughness of the base material is impaired, so the upper limit of content is made 9.0%. Note that, if considering the manufacturability and workability of the steel material, 5.5% to 7.5% is preferable. Furthermore, if considering the balance with the cost, 5.8% to 6.3% is preferable.

[Al: 0.20% to 1.50%]

Al, in the present invention, improves the stability of the passivation layer and thereby is an element as important as Cr for securing corrosion resistance. The content of Al, from the viewpoint of securing the amount of dissolved Al for improving the stability of the passivation layer, has to be 0.20% or more, On the other hand, if over 1.50% is added, the temperature range of the ferrite phase transformation becomes extremely broad which becomes a cause of cast slab cracking etc. in the production process, so the content is limited to 0.20% to 1.50%. Furthermore, if considering the workability, 0.50% to 1.30% is preferable. Furthermore, if considering the balance of the corrosion resistance, manufacturability, and cost, 0.85% to 1.20% is preferable.

[Mn: 1.50% to less than 3.00%]

Mn, in the present invention, is mainly added to secure the strength and, further, to act as an austenite-forming element so as to suppress the formation of coarse ferrite assisted by the Cr and Al added from the viewpoint of the corrosion resistance. That is, Cr and Al, as is well known, are ferrite forming elements. If these are added in large amounts, the steel will not transform in the process from solidification to reaching room temperature and will become a ferrite single-phase microstructure, cast slab cracking etc. will occur, and the manufacturability will drop.

Therefore, to obtain such an effect, Mn has to be added in an amount of 1.50% or more, but if 3.00% or more is added, the ductility of the base material remarkably falls, so it is defined to add less than 3.00%. Note that, if considering the strength, manufacturability, weldability, and workability of the steel material, 2.00% to less than 3.00% is preferable.

[N: 0.020% or less]

N, if added in a large amount to steel plate or sheet, forms nitrides etc. and thereby obstructs the ductility and corrosion resistance of the base material, so the upper limit is made 0.020%.

[P: 0.030% or less]

P is present in the steel as an impurity, but this lowers the ductility and makes the manufacturability drop, so the less, the better. The upper limit of content was made 0.030%. Furthermore, from the viewpoint of the manufacturability and cost, the content is preferably 0.020% or less.

[S: 0.0050% or less]

S, if added in a large amount, causes the pitting resistance/localized corrosion resistance to drop, so the less, the better. The upper limit of content is made 0.0050%. Note that, S and P are unavoidable impurities and should be reduced as much as possible.

In the present invention, in addition to the above elements, furthermore, by adding Cu: 0.05% to 0.50% and Ni: 0.05% to 0.50%, the rust resistance/pitting resistance and localized corrosion resistance can be improved more.

In addition, by including one or more of Mo: 0.01% to 0.20%, V: 0.005% to 0.050%, Nb: 0.005% to 0.050%, and Ti: 0.005% to less than 0.030%, it is possible to further improve the rust resistance/pitting resistance and localized corrosion resistance or improve the strength and toughness without affecting the corrosion resistance.

[Cu: 0.05% to 0.50%]

[Ni: 0.05% to 0.50%]

Cu and Ni are both elements improving the rust resistance/pitting resistance and localized corrosion resistance in the exhaust gas environment of the gas-fired plant. When added, both are added.

Cu, compared with Ni, has a larger effect of suppression of rusting and localized corrosion. However, Cu is susceptible to segregation in some respects. In particular, sometimes the local segregated parts of Cu derived from segregation in solidification between dendrites of the cast microstructure remain on the product surface. If there are such segregated parts at the product surface, in the presence of the condensed water of the high concentration carbon dioxide atmosphere in the exhaust gas environment of the gas-fired plant, a potential difference will arise between the segregated parts and their surroundings and the locations of lower potential can become starting points of localized corrosion or rusting.

In this regard, if simultaneously adding Ni, the Ni will act to mitigate the segregation of Cu. If adding both, a synergistic effect will be exhibited.

On the other hand, if not adding Cu and adding only Ni, the cost will rise, yet the amount of rise of the effect of suppression of rusting and localized corrosion will be small, but if adding Cu and Ni together, the effect of suppression of rusting and localized corrosion will remarkably be manifested. Further, if adding both Cu and Ni, there are the effects of further improving the strength and of suppressing the formation of ferrite. In particular, Ni has the effect of preventing slab cracking due to the addition of Cu and of improving the ductility/toughness of the base material by addition together with Cu.

Cu and Ni have to both be added in amounts of 0.05% or more so as to obtain these effects, but if over 0.50% of either is added, embrittlement occurs, so in both the range of limitation is made 0.05% to 0.50%. Furthermore, from the viewpoint of stable manufacturability, preferably Cu and Ni are both 0.05% to 0.30%. Furthermore, if considering the balance with cost, both are preferably 0.10% to 0.20%.

[Mo: 0.01% to 0.20%]

Mo, if added in 0.01% or more in steel in which Cr and Al are added, exhibits the effect of suppression of the formation and growth of pitting without impairing the properties of the base material. However, even if over 0.20% is added, not only will the effect be saturated, but also the ductility and toughness of the base material will be lowered. For this reason, when working the steel into a member for chimney/flue use in the gas-fired plant, cold working cracks and fine surface cracks will be caused and the material will no longer be suitable as a structural member for chimneys/flues, so the range was made 0.01% to 0.20%.

[Nb: 0.005% to 0.050%]

Nb is an element which improves the strength and toughness without impairing the corrosion resistance. Its effect is recognized starting from 0.005%, but if over 0.050%, the effect becomes saturated, so the range was made 0.005% to 0.050%.

[V: 0.005% to 0.050%]

V, like Nb, is an element which improves the strength without impairing the corrosion resistance. At 0.005% or more, an effect is recognized, but a large amount of addition obstructs the ductility, so the upper limit was made 0.050%.

[Ti: 0.005% to less than 0.030%]

Ti is an element which forms nitrides and through this contributes to the increased fineness of the crystal grains at a high temperature. It contributes to an improvement of the ductility etc. without impairing the corrosion resistance. The effect is observed starting from 0.005% or more, but with addition of 0.030% or more, carbides precipitate in large amounts, so conversely the ductility and toughness are obstructed. When worked into and used as members for gas-fired plant chimney/flue use, cold working cracks occur or the problem of a drop in toughness arises, so this is not suitable as a structural member of a gas-fired plant chimney/flue. Therefore, the range was made 0.005% to less than 0.030%.

In the present invention, furthermore, by adding one or more of any of Ca: 0.0005% to 0.010%, Mg: 0.0005% to 0.010%, and REM: 0.001% to 0.010%, it is possible to improve the rust resistance and pitting resistance/localized corrosion resistance.

[Ca: 0.0005% to 0.010%]

[Mg: 0.0005% to 0.010%]

The roles of Ca and Mg in steel containing Cr and Al are unclear in many points, but these are elements which, by addition to the steel, selectively dissolve in the environment and form alkali environments on the surface of the steel plate or sheet, so contribute to an improvement of the corrosion resistance. Whatever the case, if 5 ppm or more, an improvement in the corrosion resistance is recognized, but if over 100 ppm is added, the effect of improvement of the corrosion resistance becomes saturated. Not only this, there is a clear trend toward a drop in the ductility or toughness of the base material. The amount of addition is limited to 5 ppm to 100 ppm (0.0005% to 0.010%).

[REM: 0.001% to 0.010%]

In the present invention, even if suitably adding a rare earth metal (REM), it is possible to improve the ductility of the base material without impairing the corrosion resistance. The amount of addition has to be 0.001% or more, but addition of a large amount obstructs this, so the upper limit is made 0.010%.

Regarding the method of production of a steel material of the present invention, this is produced by using a steel slab having the compositions explained above as a starting material and subjecting it to heating, a rolling step, and, if necessary, a heat treatment step. The steel slab is produced by adjusting in compositions and smelting steel by a converter or electric furnace, then using a continuous casting method and slabbing/blooming method or other process. The steel slab may be heated, then hot rolled to a steel plate or sheet, steel shape, steel pipe, etc. Even if quenched, tempered, normalized, or otherwise heat treated in accordance with the objective, this has no effect at all on the corrosion resistance of the steel.

[Inorganic Zinc-Rich Paint Layer]

The steel for chimney/flue use of the present invention is characterized by comprising a base steel material of the above composition on the surface of which an inorganic zinc-rich paint layer is provided.

The inorganic zinc-rich paint layer has to have a coating thickness of 5 to 100 μm. If the coating thickness is less than 5 μm, the effect of the inorganic zinc-rich paint becomes harder to obtain, while if over 100 μm, cracking and dripping become easier and the corrosion resistance falls. Furthermore, the inorganic zinc-rich paint layer becomes more susceptible to fumes and blow holes at the time of torch cutting and welding and worse in installation ability the greater the coating thickness. Further, if considering the balance of the installation, corrosion resistance, and economy, the coating thickness is preferably 10 to 30 μm.

Further, the inorganic zinc-rich paint layer used has to be one containing metal zinc in the dried coating film in an amount of 30 mass % or more. Usually, the composition of the inorganic zinc-rich paint used is frequently one using the alkyl-silicate or ethyl silicate or other silicate condensate as a vehicle. Further, the layer is not particularly defined so long as the metal zinc in what remains after heating is 30% or more, but one corresponding to JIS K 5552 Type 1 is preferable from the viewpoint of reliability.

The method of formation of the inorganic zinc-rich paint layer is not particularly limited. It is possible to coat the steel material with an inorganic zinc-rich paint by brushing or spraying so as to form an inorganic zinc-rich paint layer on the surface of the steel material. However, before coating or spraying an inorganic zinc-rich paint, shot blasting or sandblasting is preferably used to remove the rust from the surface of the steel material from the viewpoint of adhesion. Further, as the level of the blasting, the Sa1/2 or more shown in ISO 8501-1 is preferable. Further, when spraying the blasted steel material surface with an inorganic zinc-rich paint, it is preferable to use an air-less spray for spraying from the viewpoint of the work efficiency.

In the steel for chimney/flue use of the present invention, by forming a heat resistant silicone-based resin layer on the surface of the inorganic zinc-rich paint layer, it is possible to obtain a further long-term durability.

The thickness of the heat resistant silicone-based resin layer, if considering the balance of corrosion resistance and economy, is preferably 100 to 400 μm. However, from the viewpoint of installation and weldability, making it 150 to 250 μm is more preferable.

As the method of installation of the heat resistant silicone-based resin layer, the method of coating the surface of the inorganic zinc-rich paint layer with a silicone-based resin coating by an air-less or air spray etc. to give a thickness of the dried coating film of the desired thickness and then drying at ordinary temperature for finishing may be mentioned. As the heat resistant silicone-based resin coating, one having an ordinary temperature curability, chemical resistance, and adhesion is sufficient.

### EXAMPLES

Below, examples will be used to make the effects of the present invention clearer. Note that, the present invention is not limited to the following examples and can be suitably modified within the scope of no change of gist.

In the present embodiment, first, steels of the alloy compositions of Tables 1 to 3 were smelted and cast, were hot rolled to a plate thickness of 10 mm, were heat treated, then were fabricated into specimen. Next, the above test pieces were obtained as test pieces for actual plant exposure (200×150×10 mm) and blasted by shot blasting to obtain a Sa1/2 (ISO 8501-1) or better.

Further, the surface of the specimen were coated with an inorganic zinc-rich paint and were dried at ordinary temperature and at a relative humidity of 70% or less (hereinafter described as “RH”) for seven days to prepare various types of corrosion test pieces having inorganic zinc-rich paint layers. Note that, for the inorganic zinc-rich paint, one equivalent to Type 1 of JIS K 5552 (made by Nippon Steel Corporation, product name: NB zinc-rich primer 2000NR) was used.

Further, a silicone-based resin (made by Oshima Kogyo Co., Ltd., product name: Pyrosin B#1000) was used and coated by an air-less spray to 200 to 250 μm or so as to prepare various types of corrosion specimen.

TABLE 1

| | C | Si | Mn | P | S | Cr | Al | N | Cu | Ni |
|---|---|---|---|---|---|---|---|---|---|---|
| Inv.ex. 1 | 0.011 | 0.24 | 2.54 | 0.019 | 0.003 | 5.91 | 1.09 | 0.0065 | 0.11 | 0.08 |
| Inv.ex. 2 | 0.011 | 0.18 | 1.55 | 0.005 | 0.002 | 4.56 | 1.16 | 0.0077 | | |
| Inv.ex. 3 | 0.017 | 0.25 | 2.62 | 0.006 | 0.001 | 5.68 | 1.03 | 0.0065 | 0.07 | 0.05 |
| Inv.ex. 4 | 0.015 | 0.24 | 2.45 | 0.005 | 0.001 | 6.02 | 1.09 | 0.0065 | 0.14 | 0.11 |
| Inv.ex. 5 | 0.014 | 0.19 | 1.55 | 0.004 | 0.006 | 4.56 | 0.42 | 0.0077 | | |
| Inv.ex. 6 | 0.017 | 0.22 | 2.59 | 0.019 | 0.003 | 6.09 | 0.95 | 0.0010 | 0.19 | 0.08 |
| Inv.ex. 7 | 0.022 | 0.25 | 1.58 | 0.004 | 0.004 | 7.23 | 0.55 | 0.0065 | 0.11 | 0.05 |
| Inv.ex. 8 | 0.011 | 0.24 | 2.45 | 0.005 | 0.002 | 6.02 | 1.03 | 0.0065 | 0.15 | 0.09 |
| Inv.ex. 9 | 0.015 | 0.24 | 2.54 | 0.008 | 0.002 | 5.63 | 0.95 | 0.0075 | 0.19 | 0.12 |
| Inv.ex. 10 | 0.014 | 0.25 | 1.54 | 0.005 | 0.001 | 6.12 | 1.20 | 0.0045 | | |
| Inv.ex. 11 | 0.011 | 0.28 | 2.68 | 0.007 | 0.002 | 6.09 | 1.05 | 0.0075 | 0.11 | 0.09 |
| Inv.ex. 12 | 0.014 | 0.18 | 2.88 | 0.004 | 0.002 | 4.11 | 0.55 | 0.0077 | | |
| Inv.ex. 13 | 0.020 | 0.20 | 2.75 | 0.004 | 0.006 | 9.00 | 1.35 | 0.0065 | 0.49 | 0.48 |
| Inv.ex. 14 | 0.015 | 0.19 | 2.46 | 0.008 | 0.002 | 5.91 | 1.03 | 0.0088 | 0.12 | 0.37 |
| Inv.ex. 15 | 0.015 | 0.30 | 2.69 | 0.019 | [0.0008 | 5.63 | 1.05 | 0.0065 | 0.19 | 0.12 |
| Inv.ex. 16 | 0.016 | 0.20 | 2.58 | 0.008 | 0.002 | 5.91 | 0.92 | 0.0065 | 0.11 | 0.34 |
| Inv.ex. 17 | 0.016 | 0.46 | 2.54 | 0.008 | 0.002 | 5.91 | 0.92 | 0.0075 | 0.11 | 0.22 |
| Inv.ex. 18 | 0.015 | 0.33 | 2.44 | 0.007 | 0.001 | 4.32 | 1.49 | 0.0045 | | |
| Inv.ex. 19 | 0.021 | 0.68 | 2.75 | 0.008 | [0.0003 | 8.05 | 0.85 | 0.0077 | 0.15 | 0.05 |
| Inv.ex. 20 | 0.021 | 0.24 | 2.11 | 0.008 | 0.001 | 5.91 | 1.09 | 0.0075 | 0.11 | 0.16 |
| Inv.ex. 21 | 0.024 | 0.39 | 1.50 | 0.025 | [0.0006 | 7.26 | 0.26 | 0.0065 | 0.05 | 0.10 |
| Inv.ex. 22 | 0.015 | 0.21 | 2.51 | 0.006 | 0.003 | 5.63 | 0.95 | 0.0075 | 0.48 | 0.08 |
| Inv.ex. 23 | 0.017 | 0.47 | 2.68 | 0.008 | 0.002 | 5.91 | 0.92 | 0.0075 | 0.19 | 0.12 |
| | | | | | | Mo | Nb | V | Ti | Ca, Mg, REM |
| | | | | | Inv.ex. 1 | | | 0.039 | 0.009 | |
| | | | | | Inv.ex. 2 | | | | | |
| | | | | | Inv.ex. 3 | | | | | |
| | | | | | Inv.ex. 4 | | | | | |
| | | | | | Inv.ex. 5 | 0.18 | | | | |
| | | | | | Inv.ex. 6 | | 0.025 | | 0.026 | |
| | | | | | Inv.ex. 7 | 0.13 | | | | |
| | | | | | Inv.ex. 8 | | | | | |
| | | | | | Inv.ex. 9 | | | | | |
| | | | | | Inv.ex. 10 | | 0.018 | | | |
| | | | | | Inv.ex. 11 | | | | | |
| | | | | | Inv.ex. 12 | | | 0.007 | | |
| | | | | | Inv.ex. 13 | | | | 0.026 | |
| | | | | | Inv.ex. 14 | 0.20 | | | | Ca: 0.0007 |
| | | | | | Inv.ex. 15 | 0.08 | | | | Mg: 0.0008 |
| | | | | | Inv.ex. 16 | | | 0.028 | | |
| | | | | | Inv.ex. 17 | 0.19 | | | 0.021 | |
| | | | | | Inv.ex. 18 | | | | | |
| | | | | | Inv.ex. 19 | | | | | Ca: 0.0010 |
| | | | | | Inv.ex. 20 | 0.15 | 0.015 | | | |
| | | | | | Inv.ex. 21 | | | | | Mg: 0.0008 |
| | | | | | Inv.ex. 22 | | | | | |
| | | | | | Inv.ex. 23 | | | | | |

Empty cells mean not intentionally added.

TABLE 2

| | C | Si | Mn | P | S | Cr | Al | N | Cu | Ni | Mo |
|---|---|---|---|---|---|---|---|---|---|---|---|
| Inv.ex. 24 | 0.029 | 0.24 | 2.54 | 0.019 | 0.003 | 5.91 | 0.95 | 0.0065 | 0.11 | 0.11 | |
| Inv.ex. 25 | 0.014 | 0.49 | 2.06 | 0.003 | 0.003 | 4.01 | 0.21 | 0.0162 | | | |
| Inv.ex. 26 | 0.024 | 0.43 | 2.54 | 0.008 | 0.002 | 5.91 | 0.92 | 0.0088 | 0.15 | 0.08 | |
| Inv.ex. 27 | 0.014 | 0.19 | 1.86 | 0.008 | 0.001 | 4.33 | 0.64 | 0.0149 | | | 0.08 |
| Inv.ex. 28 | 0.017 | 0.36 | 1.86 | 0.001 | 0.002 | 8.05 | 1.45 | 0.0074 | | | |
| Inv.ex. 29 | 0.015 | 0.24 | 2.54 | 0.008 | 0.002 | 5.91 | 1.03 | 0.0065 | 0.11 | 0.07 | |
| Inv.ex. 30 | 0.014 | 0.45 | 2.38 | 0.004 | 0.006 | 7.06 | 1.38 | 0.0085 | 0.05 | 0.11 | |
| Inv.ex. 31 | 0.026 | 0.34 | 2.75 | 0.004 | 0.005 | 4.52 | 1.50 | 0.0077 | 0.15 | 0.05 | 0.20 |
| Inv.ex. 32 | 0.022 | 0.30 | 2.69 | 0.005 | 0.003 | 6.09 | 0.95 | 0.0075 | 0.38 | 0.12 | |
| Inv.ex. 33 | 0.011 | 0.20 | 2.44 | 0.005 | 0.003 | 8.15 | 0.32 | 0.0065 | 0.05 | 0.11 | 0.15 |
| Inv.ex. 34 | 0.017 | 0.19 | 2.68 | 0.008 | 0.001 | 6.02 | 1.05 | 0.0010 | 0.11 | 0.05 | |
| Inv.ex. 35 | 0.015 | 0.28 | 2.68 | 0.007 | 0.002 | 6.09 | 0.95 | 0.0065 | 0.19 | 0.09 | 0.05 |
| Inv.ex. 36 | 0.017 | 0.29 | 2.35 | 0.019 | 0.003 | 5.90 | 1.05 | 0.0075 | 0.19 | 0.12 | 0.15 |
| Inv.ex. 37 | 0.029 | 0.31 | 2.75 | 0.003 | 0.004 | 7.06 | 0.61 | 0.0042 | | | |
| Inv.ex. 38 | 0.007 | 0.19 | 1.72 | 0.008 | 0.008 | 4.26 | 0.95 | 0.0077 | | | |
| Inv.ex. 39 | 0.015 | 0.30 | 2.69 | 0.019 | 0.003 | 5.63 | 0.95 | 0.0075 | 0.19 | 0.12 | |
| Inv.ex. 40 | 0.017 | 0.25 | 2.68 | 0.008 | 0.003 | 6.02 | 1.05 | 0.0075 | 0.11 | 0.22 | |
| Inv.ex. 41 | 0.015 | 0.48 | 2.75 | 0.004 | 0.006 | 4.58 | 0.52 | 0.0077 | | | |
| Inv.ex. 42 | 0.019 | 0.24 | 2.55 | 0.005 | 0.001 | 5.91 | 1.09 | 0.0075 | 0.12 | 0.09 | 0.03 |
| Inv.ex. 43 | 0.014 | 0.31 | 1.62 | 0.004 | 0.005 | 5.41 | 0.48 | 0.0065 | 0.29 | 0.36 | 0.15 |
| Inv.ex. 44 | 0.015 | 0.24 | 2.54 | 0.008 | [0.0009 | 5.91 | 0.95 | 0.0075 | 0.15 | 0.22 | |
| Inv.ex. 45 | 0.029 | 0.21 | 2.51 | 0.006 | 0.003 | 5.90 | 0.90 | 0.0075 | 0.11 | 0.08 | 0.05 |
| Inv.ex. 46 | 0.017 | 0.48 | 2.06 | 0.009 | 0.007 | 7.05 | 0.21 | 0.0065 | | | |
| | | | | | | | | Nb | V | Ti | Ca, Mg, REM |
| | | | | | | | Inv.ex. 24 | | | | |
| | | | | | | | Inv.ex. 25 | | | | REM: 0.003 |
| | | | | | | | Inv.ex. 26 | | | | |
| | | | | | | | Inv.ex. 27 | | | | |
| | | | | | | | Inv.ex. 28 | 0.041 | | | |
| | | | | | | | Inv.ex. 29 | | | | |
| | | | | | | | Inv.ex. 30 | | | | |
| | | | | | | | Inv.ex. 31 | | | | |
| | | | | | | | Inv.ex. 32 | | | | Ca: 0.0050 |
| | | | | | | | Inv.ex. 33 | | | | |
| | | | | | | | Inv.ex. 34 | | | | Mg: 0.0030 |
| | | | | | | | Inv.ex. 35 | | 0.049 | | |
| | | | | | | | Inv.ex. 36 | | | | REM: 0.001 |
| | | | | | | | Inv.ex. 37 | | 0.008 | | |
| | | | | | | | Inv.ex. 38 | | | | |
| | | | | | | | Inv.ex. 39 | | | | |
| | | | | | | | Inv.ex. 40 | | | | |
| | | | | | | | Inv.ex. 41 | | | | Mg: 0.0008 |
| | | | | | | | Inv.ex. 42 | | | | |
| | | | | | | | Inv.ex. 43 | | | | |
| | | | | | | | Inv.ex. 44 | | | 0.010 | |
| | | | | | | | Inv.ex. 45 | | | | |
| | | | | | | | Inv.ex. 46 | | | | |

Empty cells mean not intentionally added.

TABLE 3

| | C | Si | Mn | P | S | Cr | Al | N | Cu | Ni | Mo |
|---|---|---|---|---|---|---|---|---|---|---|---|
| Inv.ex. 47 | 0.006 | 0.21 | 2.51 | 0.006 | 0.003 | 5.90 | 0.90 | 0.0010 | 0.12 | 0.08 | |
| Inv.ex. 48 | 0.015 | 0.21 | 2.61 | 0.006 | 0.003 | 5.90 | 0.90 | 0.0075 | 0.15 | 0.08 | |
| Inv.ex. 49 | 0.029 | 0.24 | 2.54 | 0.019 | 0.003 | 5.91 | 0.95 | 0.0075 | 0.19 | 0.08 | |
| Inv.ex. 50 | 0.024 | 0.22 | 2.54 | 0.008 | 0.002 | 4.05 | 0.52 | 0.0088 | | | |
| Inv.ex. 51 | 0.015 | 0.28 | 2.69 | 0.007 | 0.002 | 6.09 | 1.05 | 0.0088 | 0.09 | 0.09 | |
| Comp.ex. 1 | 0.044 | [0.028 | 2.38 | 0.001 | 0.003 | 5.33 | 0.64 | 0.0084 | | 0.11 | |
| Comp.ex. 2 | 0.007 | 0.31 | 0.09 | 0.005 | 0.005 | 4.52 | 1.50 | 0.0077 | 0.14 | 0.10 | |
| Comp.ex. 3 | 0.014 | 0.31 | 2.75 | 0.055 | 0.003 | 8.15 | 0.32 | 0.0065 | | | |
| Comp.ex. 4 | 0.014 | 0.33 | 2.38 | 0.004 | 0.006 | 2.65 | 0.48 | 0.0077 | 0.15 | | |
| Comp.ex. 5 | 0.017 | 0.74 | 2.75 | 0.004 | 0.005 | 4.52 | [0.064 | 0.0065 | | 0.09 | |
| Comp.ex. 6 | 0.015 | [0.028 | 2.44 | 0.005 | 0.003 | 7.26 | 1.35 | 0.0235 | | | 0.20 |
| Comp.ex. 7 | 0.014 | 0.31 | 2.75 | 0.003 | 0.004 | 5.33 | 0.64 | 0.0084 | 0.66 | | |
| Comp.ex. 8 | 0.017 | 0.42 | 1.22 | 0.008 | 0.008 | 9.65 | 0.48 | 0.0065 | | | 0.15 |
| Comp.ex. 9 | 0.014 | 0.31 | 1.22 | 0.004 | 0.005 | 7.26 | 0.54 | 0.0065 | | 0.73 | |
| Comp.ex. 10 | 0.012 | 0.25 | 2.12 | 0.009 | 0.005 | 6.11 | 1.23 | 0.0068 | 0.69 | 0.55 | |
| Comp.ex. 11 | 0.013 | 0.15 | 1.93 | 0.008 | 0.004 | 6.24 | 0.25 | 0.0066 | | | |
| Comp.ex. 12 | 0.034 | 0.28 | 1.97 | 0.005 | 0.005 | 7.65 | 1.11 | 0.0070 | | | |
| Comp.ex. 13 | 0.034 | 0.31 | 2.03 | 0.004 | 0.005 | 7.59 | 1.20 | 0.0068 | 0.16 | 0.20 | |
| Comp.ex. 14 | 0.012 | 0.15 | 2.06 | 0.003 | 0.002 | 5.36 | 0.85 | 0.0045 | | | |
| Comp.ex. 15 | 0.015 | 0.26 | 2.53 | 0.001 | 0.001 | 6.32 | 1.15 | 0.0077 | 0.22 | | |
| Comp.ex. 16 | 0.024 | 0.39 | 2.89 | 0.006 | 0.007 | 6.08 | 1.12 | 0.0045 | | | 0.29 |
| Comp.ex. 17 | 0.022 | 0.46 | 1.88 | 0.001 | 0.003 | 6.08 | 1.08 | 0.0088 | 0.23 | 0.19 | |
| | | | | | | | | Nb | V | Ti | Ca, Mg, REM |
| | | | | | | | Inv.ex. 47 | | | | |
| | | | | | | | Inv.ex. 48 | | | | REM: 0.005 |
| | | | | | | | Inv.ex. 49 | | | | |
| | | | | | | | Inv.ex. 50 | | | | |
| | | | | | | | Inv.ex. 51 | 0.009 | | | |
| | | | | | | | Comp.ex. 1 | | | | |
| | | | | | | | Comp.ex. 2 | | | | |
| | | | | | | | Comp.ex. 3 | | | | |
| | | | | | | | Comp.ex. 4 | | | | |
| | | | | | | | Comp.ex. 5 | | | | |
| | | | | | | | Comp.ex. 6 | | | | Mg: 0.0008 |
| | | | | | | | Comp.ex. 7 | | 0.007 | | |
| | | | | | | | Comp.ex. 8 | 0.020 | | | REM: 0.003 |
| | | | | | | | Comp.ex. 9 | | | | |
| | | | | | | | Comp.ex. 10 | | | | |
| | | | | | | | Comp.ex. 11 | | | | |
| | | | | | | | Comp.ex. 12 | | | | |
| | | | | | | | Comp.ex. 13 | | | | |
| | | | | | | | Comp.ex. 14 | | | | |
| | | | | | | | Comp.ex. 15 | | | | |
| | | | | | | | Comp.ex. 16 | | | | |
| | | | | | | | Comp.ex. 17 | | | 0.036 | |

Empty cells mean not intentionally added.
Underlines indicate outside range of present invention.

Further, the test pieces shown in these Tables 1 to 3 were subjected to exposure tests in actual natural gas-fired and liquefied petroleum gas-fired plant chimneys/flues and evaluated for rust resistance, rust adhesion, localized corrosion resistance, and the overall level of the same. The results of examination are shown in Tables 4 to 6.

Note that, the actual plant exposure test was performed by simulating unavoidable defects by setting specimen, each given a 0.6 mm width X-cut made by a cutter so as to expose the base iron surface, inside a natural gas-fired chimney/flue and a liquefied petroleum gas-fired plant chimney/flue for about three years.

The rust resistance was evaluated by the presence of any rusting. That is, specimen for which no formation of rust could be observed by the naked eye were evaluated as “Good”, while ones for which formation could be observed were evaluated as “Poor”.

Further, the test pieces for which red rust could be observed were evaluated for rust adhesion by utilization of the method of adhesion test of JIS H 8504 and by the tape test method using adhesive tape of a nominal width of 12 mm defined in JIS Z1522 (so-called, “tape peeling test method”). That is, specimen with tape with rust at 10% or less of the area rate were judged good in adhesion and evaluated as “Good”. Specimen with an area of rust and deposits of over 10% was judged as defective and evaluated as “Poor”.

The localized corrosion resistance was evaluated by dipping a test piece into a 50° C., 10% sulfuric acid aqueous solution into which, as an inhibitor, Hibiron (registered trademark) made by Sugimura Chemical Industrial Co., Ltd. was added in an amount of 0.5%, for 20 minutes so as to completely remove the rust (under the present conditions, it was confirmed the base material did not dissolve), then a laser optical microscope was used to observe a 50×50 mm region in the center of test surface, the location of the deepest pitting was measured, 0.03 mm/year or less was judged as excellent, that is, was evaluated as “Good, while a corrosion rate of over 0.03 mm/year was judged as defective, that is, was evaluated as “Poor”.

Regarding the overall evaluation of the corrosion resistance, when even if rust is formed, the rust adhesion is excellent and the localized corrosion resistance is excellent, hole formation and rust scattering can be prevented. Therefore, specimen for which the rust resistance, rust adhesion, and localized corrosion resistance were all “Good” and specimen for which even if the rust resistance was “Poor”, the rust adhesion and localized corrosion resistance were “Good” were evaluated as “Good” (suitable), while other cases were evaluated as “Poor” (unsuitable).

Furthermore, when cold working a steel material into a chimney/flue in a natural gas-fired or liquefied petroleum gas-fired plant, to confirm that the necessary ductility is provided, the test pieces with “Good” overall evaluations of corrosion resistance were subjected to 180° cold bending tests for 6 mm plate thickness materials and were checked for the state of occurrence of cracks and fractures in the outer surface after the test by visual examination. Those for which occurrence of cracks or fine fractures could not be confirmed were evaluated as “Good”, while those for which this was confirmed were evaluated as “Poor”.

TABLE 4

| | Presence | Presence | | | | | | | | | |
|---|---|---|---|---|---|---|---|---|---|---|---|
| | of | of | | | | Liquefied petroleum gas-fired | | | Corrosion | | |
| | inorganic | silicone- | Natural gas-fired plant | | | plant | | | resistance | Cold | |
| | zinc-rich | based | Rust | Rust | Localized | Rust | Rust | Localized | overall | bending | Overall |
| | paint | resin | resistance | adhesion | corrosion | resistance | adhesion | corrosion | evaluation | test | evaluation |
| Inv.ex. 1 | Yes | No | Good | Good | Good | Good | Good | Good | Good | Good | Good |
| Inv.ex. 2 | No | No | Good | Good | Good | Poor | Good | Good | Good | Good | Good |
| Inv.ex. 3 | Yes | Yes | Good | Good | Good | Good | Good | Good | Good | Good | Good |
| Inv.ex. 4 | Yes | No | Good | Good | Good | Good | Good | Good | Good | Good | Good |
| Inv.ex. 5 | No | Yes | Good | Good | Good | Good | Good | Good | Good | Good | Good |
| Inv.ex. 6 | Yes | Yes | Good | Good | Good | Good | Good | Good | Good | Good | Good |
| Inv.ex. 7 | No | No | Poor | Good | Good | Poor | Good | Good | Good | Good | Good |
| Inv.ex. 8 | Yes | No | Good | Good | Good | Good | Good | Good | Good | Good | Good |
| Inv.ex. 9 | No | Yes | Good | Good | Good | Good | Good | Good | Good | Good | Good |
| Inv.ex. 10 | Yes | No | Good | Good | Good | Good | Good | Good | Good | Good | Good |
| Inv.ex. 11 | No | No | Good | Good | Good | Good | Good | Good | Good | Good | Good |
| Inv.ex. 12 | No | Yes | Good | Good | Good | Good | Good | Good | Good | Good | Good |
| Inv.ex. 13 | Yes | Yes | Good | Good | Good | Good | Good | Good | Good | Good | Good |
| Inv.ex. 14 | Yes | Yes | Good | Good | Good | Good | Good | Good | Good | Good | Good |
| Inv.ex. 15 | Yes | No | Good | Good | Good | Good | Good | Good | Good | Good | Good |
| Inv.ex. 16 | Yes | No | Good | Good | Good | Good | Good | Good | Good | Good | Good |
| Inv.ex. 17 | Yes | No | Good | Good | Good | Good | Good | Good | Good | Good | Good |
| Inv.ex. 18 | No | No | Poor | Good | Good | Good | Good | Good | Good | Good | Good |
| Inv.ex. 19 | Yes | No | Good | Good | Good | Good | Good | Good | Good | Good | Good |
| Inv.ex. 20 | Yes | No | Good | Good | Good | Good | Good | Good | Good | Good | Good |
| Inv.ex. 21 | Yes | No | Good | Good | Good | Good | Good | Good | Good | Good | Good |
| Inv.ex. 22 | Yes | Yes | Good | Good | Good | Good | Good | Good | Good | Good | Good |
| Inv.ex. 23 | No | No | Poor | Good | Good | Poor | Good | Good | Good | Good | Good |

TABLE 5

| | Presence | Presence | | | | | | | | | |
|---|---|---|---|---|---|---|---|---|---|---|---|
| | of | of | | | | Liquefied petroleum gas-fired | | | Corrosion | | |
| | inorganic | silicone- | Natural gas-fired plant | | | plant | | | resistance | Cold | |
| | zinc-rich | based | Rust | Rust | Localized | Rust | Rust | Localized | overall | bending | Overall |
| | paint | resin | resistance | adhesion | corrosion | resistance | adhesion | corrosion | evaluation | test | evaluation |
| Inv.ex. 24 | Yes | No | Good | Good | Good | Good | Good | Good | Good | Good | Good |
| Inv.ex. 25 | Yes | No | Good | Gcod | Good | Good | Good | Good | Good | Good | Good |
| Inv.ex. 26 | No | Yes | Good | Good | Good | Good | Good | Good | Good | Good | Good |
| Inv.ex. 27 | Yes | No | Good | Good | Good | Good | Good | Good | Good | Good | Good |
| Inv.ex. 28 | No | Yes | Good | Good | Good | Good | Good | Good | Good | Good | Good |
| Inv.ex. 29 | Yes | Yes | Good | Good | Good | Good | Good | Good | Good | Good | Good |
| Inv.ex. 30 | No | No | Poor | Good | Good | Poor | Good | Good | Good | Good | Good |
| Inv.ex. 31 | Yes | No | Good | Good | Good | Good | Good | Good | Good | Good | Good |
| Inv.ex. 32 | Yes | No | Good | Good | Good | Good | Good | Good | Good | Good | Good |
| Inv.ex. 33 | No | No | Good | Good | Good | Good | Good | Good | Good | Good | Good |
| Inv.ex. 34 | Yes | No | Good | Good | Good | Good | Good | Good | Good | Good | Good |
| Inv.ex. 35 | Yes | No | Good | Good | Good | Good | Good | Good | Good | Good | Good |
| Inv.ex. 36 | No | No | Poor | Good | Good | Poor | Good | Good | Good | Good | Good |
| Inv.ex. 37 | Yes | No | Good | Good | Good | Good | Good | Good | Good | Good | Good |
| Inv.ex. 38 | No | Yes | Good | Good | Good | Good | Good | Good | Good | Good | Good |
| Inv.ex. 39 | No | Yes | Good | Good | Good | Good | Good | Good | Good | Good | Good |
| Inv.ex. 40 | Yes | No | Good | Good | Good | Good | Good | Good | Good | Good | Good |
| Inv.ex. 41 | Yes | No | Good | Good | Good | Good | Good | Good | Good | Good | Good |
| Inv.ex. 42 | Yes | Yes | Good | Good | Good | Good | Good | Good | Good | Good | Good |
| Inv.ex. 43 | No | No | Poor | Good | Good | Poor | Good | Good | Good | Good | Good |
| Inv.ex. 44 | Yes | Yes | Good | Good | Good | Good | Good | Good | Good | Good | Good |
| Inv.ex. 45 | Yes | No | Good | Good | Good | Good | Good | Good | Good | Good | Good |

TABLE 6

| | Presence | Presence | | | | | | | | | |
|---|---|---|---|---|---|---|---|---|---|---|---|
| | of | of | | | | Liquefied petroleum gas-fired | | | Corrosion | | |
| | inorganic | silicone- | Natural gas-fired plant | | | plant | | | resistance | Cold | |
| | zinc-rich | based | Rust | Rust | Localized | Rust | Rust | Localized | overall | bending | Overall |
| | paint | resin | resistance | adhesion | corrosion | resistance | adhesion | corrosion | evaluation | test | evaluation |
| Inv.ex. 46 | Yes | Yes | Good | Good | Good | Good | Good | Good | Good | Good | Good |
| Inv.ex. 47 | Yes | No | Good | Good | Good | Good | Good | Good | Good | Good | Good |
| Inv.ex. 48 | Yes | No | Good | Good | Good | Good | Good | Good | Good | Good | Good |
| Inv.ex. 49 | Yes | No | Good | Good | Good | Good | Good | Good | Good | Good | Good |
| Inv.ex. 50 | Yes | No | Good | Good | Good | Good | Good | Good | Good | Good | Good |
| Inv.ex. 51 | Yes | No | Good | Good | Good | Good | Good | Good | Good | Good | Good |
| Comp.ex. 1 | No | No | Poor | Poor | Poor | Poor | Poor | Poor | Poor | — | Poor |
| Comp.ex. 2 | No | No | Poor | Poor | Poor | Poor | Poor | Poor | Poor | — | Poor |
| Comp.ex. 3 | No | Yes | Poor | Poor | Poor | Poor | Poor | Poor | Poor | — | Poor |
| Comp.ex. 4 | No | No | Poor | Poor | Poor | Poor | Poor | Poor | Poor | — | Poor |
| Comp.ex. 5 | Yes | No | Poor | Poor | Poor | Poor | Poor | Poor | Poor | — | Poor |
| Comp.ex. 6 | Yes | No | Poor | Poor | Poor | Poor | Poor | Poor | Poor | — | Poor |
| Comp.ex. 7 | Yes | No | Poor | Poor | Poor | Poor | Poor | Poor | Poor | — | Poor |
| Comp.ex. 8 | Yes | Yes | Poor | Good | Poor | Poor | Good | Poor | Poor | — | Poor |
| Comp.ex. 9 | Yes | Yes | Poor | Good | Poor | Poor | Good | Poor | Poor | — | Poor |
| Comp.ex. 10 | No | No | Good | Good | Poor | Good | Good | Poor | Poor | — | Poor |
| Comp.ex. 11 | No | No | Poor | Good | Poor | Poor | Good | Poor | Poor | — | Poor |
| Comp.ex. 12 | No | No | Poor | Good | Poor | Poor | Good | Poor | Poor | — | Poor |
| Comp.ex. 13 | No | No | Poor | Good | Poor | Poor | Good | Poor | Poor | — | Poor |
| Comp.ex. 14 | No | No | Poor | Good | Poor | Poor | Good | Poor | Poor | — | Poor |
| Comp.ex. 15 | No | No | Good | Good | Poor | Good | Good | Poor | Poor | — | Poor |
| Comp.ex. 16 | No | No | Good | Good | Good | Good | Good | Good | Good | Poor | Poor |
| Comp.ex. 17 | No | No | Good | Good | Good | Good | Good | Good | Good | Poor | Poor |

In the cold bending test, “—” indicates not performed.

As shown in Tables 4 to 6, the specimen of Invention Examples 1 to 51 exhibited excellent results in all of the rust resistance, rust adhesion, and localized corrosion resistance. Furthermore, regarding the cold workability considered necessary for corrosion-resistant steel for chimney/flue use as well, as shown by the cold bending test results, by visual examination, it was possible to confirm that no cracks or fractures occurred in the outer surface and there was sufficient ductility as required for working.

On the other hand, the specimen of Comparative Examples 1 to 15 failed to exhibit satisfactory results for at least rust resistance and localized corrosion resistance. Furthermore, Comparative Examples 16 and 17 are high in amount of No or Ti, so in the evaluation of the corrosion resistance, were “Good”, but in the cold bending test, the occurrence of cracks was observed.

From these results, it was possible to confirm the above-mentioned discovery and, further, was possible to verify the grounds for limitation of the above-mentioned steel compositions.

1. Corrosion-resistant steel for chimney/flue use in natural gas-fired or liquefied petroleum gas-fired plants, excellent in rust resistance, rust adhesion, and localized corrosion resistance, characterized by containing, by mass %,
C: 0.005% to 0.030%,
Si: 0.18% to 0.50%,
Mn: 1.50% to less than 3.00,
P: 0.030% or less,
S: 0.0050% or less,
Cr: 4.0% to 9.0%,
Al: 0.20% to 1.50%,
N: 0.020% or less, and
having a balance of Fe and unavoidable impurities.

2. Corrosion-resistant steel for chimney/flue use in natural gas-fired or liquefied petroleum gas-fired plants as set forth in claim 1, characterized by further containing, by mass %,
Cu: 0.05% to 0.50% and
Ni: 0.05% to 0.50%.

3. Corrosion-resistant steel for chimney/flue use in natural gas-fired or liquefied petroleum gas-fired plants as set forth in claim 1 or 2, characterized by further containing, by mass %, one or more of
Mo: 0.01% to 0.20%,
V: 0.005% to 0.050%,
Nb: 0.005% to 0.050%, and
Ti: 0.005% to less than 0.030%.

4. Corrosion-resistant steel for chimney/flue use in natural gas-fired or liquefied petroleum gas-fired plants as set forth in claim 1 or 2, characterized by further containing, by mass %, one or more of
Ca: 0.0005% to 0.010%,
Mg: 0.0005% to 0.010%, and
REM: 0.001% to 0.010%.

5. Corrosion-resistant steel for chimney/flue use in natural gas-fired or liquefied petroleum gas-fired plants as set forth in claim 1 or 2, characterized in that it has on its surface a 5 to 100 μm thick inorganic zinc-rich paint layer containing metal zinc in an amount of 30 mass % or more.

6. Corrosion-resistant steel for chimney/flue use in natural gas-fired or liquefied petroleum gas-fired plants as set forth in claim 5, characterized in that it has, on an outer surface side of said inorganic zinc-rich paint layer, a 20 to 400 μm thick silicone-based resin layer.
